(19) United States
(12) Patent Application Publication
(10) Pub. No.: US 2006/0057627 A1
(43) Pub. Date: Mar. 16, 2006

(54) Selection scheme for enzymatic function

(75) Inventors: Andrew D. Ellington, Austin, TX (US); Jijumon Chelliserrykattil, Redwood City, CA (US)

Correspondence Address: CHALKER FLORES, LLP, 2711 LBJ FRWY, Suite 1036, DALLAS, TX, 75234, US

(73) Assignee: Board Of Regents, The University Of Texas System, Austin, TX (US)

(21) Appl. No.: 11/221,510

(22) Filed: Sep. 8, 2005

Related U.S. Application Data
(60) Provisional application No. 60/608,225, filed on Sep. 8, 2004.

(51) Int. Cl. C40B 30/06; C40B 40/08

(52) U.S. Cl. 435/6

(57) ABSTRACT

The present invention includes compositions and methods of selecting functional genetic elements that includes selecting in vivo an autogene operon with one or more mutagenized functional genetic elements and one or more selectable elements, wherein survival of the autogene depends on expression of the one or more mutagenized functional genetic elements and one or more selectable elements.

This application claims priority to U.S. Provisional Patent Applications Ser. No. 60/608,225, filed Sep. 8, 2004, the entire contents of which are incorporated herein by reference.

This invention was made with U.S. Government support under Contract No. N00014-99-1-0861 awarded by the Office of Naval Research. The government has certain rights in this invention.

### TECHNICAL FIELD OF THE INVENTION

The present invention relates in general to the field of enzymatic manipulation, and more particularly, to compositions and methods for making, isolating, characterizing and improving enzymes.

### BACKGROUND OF THE INVENTION

Without limiting the scope of the invention, its background is described in connection with polymerases.

Directed evolution strategies have previously been used to evolve DNA polymerases with enhanced activity,⁶ greater thermostability,⁷ ability to use ribonucleotide analogs,^{8, 9} and to evolve a DNA polymerase that can incorporate 2′O-methyl nucleotides with limited processivity.¹⁰ Several modified nucleotides and unnatural base pairs have also been reported that are recognized and replicated by DNA polymerases,^{11, 12, 13} RNA polymerase^{14, 15} and recently by a reverse transcriptase¹⁶ with various degrees of efficiency and fidelity. In contrast, initial efforts to modulate the substrate recognition of T7 RNA polymerase relied on rational design.^{17, 18} Moreover, very few natural RNA polymerase variants have been identified, which means that overall there are neither selected, designed, nor natural RNA polymerases that can be screened for the incorporation of modified nucleotides.

One of the major challenges for all RNA-based technologies is the instability of RNA. RNA is used as a diagnostic or a therapeutic tool. For example, RNA interference is now proving to be a very powerful technique with many different applications. The advancement in this field is limited by the inherent instability of RNA in vivo. In this regard, the availability of a polymerase that can synthesize modified RNA for RNAi studies could prove to be useful. Modified RNAs will remain intact during transport, storage, handling and during processes such as electrophoresis, chromatography, or centrifugation.

### SUMMARY OF THE INVENTION

The present invention includes compositions and methods for selecting functional genetic elements and uses of the same. In one embodiment, the method includes the step of selecting in vivo an autogene operon including one or more mutagenized functional genetic elements and one or more selectable elements, wherein propagation of the autogene depends on expression of the one or more mutagenized functional genetic elements and one or more selectable elements. The in vivo selection may be followed by one or more rounds of in vitro amplification and in vivo selection. Examples of functional genetic element includes polymerase genes, an exon, a promoter, an enhancer, a suppressor, a short interfering RNA (siRNA); a micro, interfering RNA (miRNA); a small, temporal RNA (stRNA); or a short, hairpin RNA (shRNA) or combinations thereof. The autogene operon may direct the synthesis of a detectable marker, e.g., an intracellular protein, a secreted protein, a cell surface protein, or combinations thereof. Examples of detectable markers include fluorescent proteins, GFP, luminescent proteins, luciferase, or enzymes that can generate fluorescent or luminescent products, e.g., alkaline phosphatase or combinations thereof.

When used with a selectable marker, such a marker for use with the present invention may confer antibiotic resistance to the cell, resistance to viral infection, autotrophic resistance, genetic complementation, enzymatic complementation, a cofactor, resistance against a toxin, a genetic cross-over point or combinations thereof. The method may further include mutagenizing the template containing the nucleic acid components, e.g., the one or more functional genetic elements or nucleic acid components. The nucleic acid components is a gene for a tRNA, and one of the nucleic acid components include a codon that binds that tRNA, or even a codon that will bind the tRNA charged by that tRNA synthetase.

Another method of the present invention allows for the selection and/or isolation of enzymatic variants of a gene by making an autogene library by randomizing one or more residues in the active site of a RNA polymerase enzyme under the control of its own promoter and expressing the autogene library in vivo. The method may also include the step of amplifying in vitro the gene encoding the RNA polymerase enzyme. The amplified variants may also be sequenced, purified and tested by in vitro transcription assays using various normal and modified nucleotides. Examples of polymerase for use in the autogene of the present invention include: DNA polymerase, an RNA polymerase, a Reverse Transcriptase or a thermostable DNA polymerase, a thermostable RNA polymerase, a thermostable Reverse Transcriptase or mutants thereof. When the invention uses an RNA polymerase as the gene, one or more marker can be screened or selected under the control of the RNA polymerase promoter and cells containing RNA polymerase variants are isolated by screening or selection.

In one embodiment, the gene is a polymerase, which may incorporate one or more non-traditional nucleotides, one or more unnatural nucleotides or combinations thereof. For example, an RNA polymerase may incorporate ribonucleotides modified at the 2′ position, the RNA polymerase may be a T7 RNA polymerase with one or more of the following mutations: Tyr639Val, His784Gly, Glu593Gly, Val685Ala. The RNA polymerase may also be screened for initiation with non-canonical nucleotides, use of different promoter sequences, improved activity, thermostability, or combinations thereof. The selectable marker may be, e.g., a CAT, a β-lactamase, an aminoglycoside kinase, or other antibiotic resistance marker.

Another embodiment of the present invention is a vector that includes a polymerase promoter, a mutant polymerase under the control of the polymerase promoter and a selectable marker under the control of the polymerase promoter. The vector may be incorporated into a host cell. The vector may be introduced into one or more cells that are deficient in nucleotide synthesis a vector that includes an RNA polymerase promoter, a mutant RNA polymerase under the control of the polymerase promoter and a selectable marker under the control of the RNA polymerase promoter; and selecting for one or more cells that survive selection. The cells may be eukaryotic, bacterial or virally infected cells. The vector may be a phagemid.

Yet another method for selecting functional genetic elements may include selecting in vivo an autogene operon having one or more mutagenized functional genetic elements and one or more screenable elements, wherein propagation of the autogene depends on expression of the one or more mutagenized functional genetic elements and one or more screenable elements. The selectable marker may confers antibiotic resistance to the cell, resistance to viral infection, autotrophic resistance, genetic complementation, enzymatic complementation, a cofactor, resistance against a toxin, a genetic cross-over point or combinations thereof. Alternatively, the method of selecting and screening of polymerases may include the step of selecting for one or more cells having a vector that includes a polymerase promoter, a mutant polymerase under the control of the polymerase promoter and an antibiotic resistance element under the control of the polymerase promoter.

### BRIEF DESCRIPTION OF THE DRAWINGS

For a more complete understanding of the features and advantages of the present invention, reference is now made to the detailed description of the invention along with the accompanying figures and in which:

FIG. 1A shows an autogene selection for active T7 RNA polymerase variants;

FIG. 1B through 1E are graphs that shows the relative activity of selected variants;

FIG. 2A through 2E are gels that show the polymerase activity and the incorporation of 2′-O-methyl ribonucleotides; and

FIG. 3A through 3C are gels demonstrating the fidelity of the enzymes of the present invention.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity, but include the general class of which a specific example may be used for illustration. The terminology herein is used to describe specific embodiments of the invention, but their usage does not delimit the invention, except as outlined in the claims.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

As used herein, the term “gene” means the coding region of a deoxyribonucleotide sequence encoding the amino acid sequence of a protein. The term includes sequences located adjacent to the coding region on both the 5′ and 3′ ends such that the deoxyribonucleotide sequence corresponds to the length of the full-length mRNA for the protein. The term “gene” encompasses both cDNA and genomic forms of a gene. A genomic form or clone of a gene contains the coding region interrupted with non-coding sequences termed “introns” or “intervening regions” or “intervening sequences.” Introns are segments of a gene that are transcribed into nuclear RNA (hnRNA); introns may contain regulatory elements such as enhancers. Introns are removed, excised or “spliced out” from the nuclear or primary transcript; introns therefore are absent in the messenger RNA (mRNA) transcript. The mRNA functions during translation to specify the sequence or order of amino acids in a nascent polypeptide. A gene product expressed from the gene in the vector comprises an epitope tag selected from a His-tag, a myc-tag, a FLAG-tag, a GST, an MBP, or combinations thereof. In specific examples, a gene for use with the present invention is a DNA polymerase, an RNA polymerase, a Reverse Transcriptase, a thermostable DNA polymerase, a thermostable RNA polymerase, a thermostable Reverse Transcriptase or mutants thereof.

In addition to containing introns, genomic forms of a gene may also include sequences located on both the 5′ and 3′ end of the sequences that are present on the RNA transcript. These sequences are referred to as “flanking” sequences or regions (these flanking sequences are located 5′ or 3′ to the non-translated sequences present on the mRNA transcript). The 5′ flanking region may contain regulatory sequences such as promoters and enhancers that control or influence the transcription of the gene. The 3′ flanking region may contain sequences that direct the termination of transcription, posttranscriptional cleavage and polyadenylation.

As used herein, the term “autogene” is used to describe a gene product that is responsible for its own expression, e.g., a T7 RNA polymerase that is under the operable control of its own promoter. Other examples of autogenes for use with the present invention may include, DNA polymerases, reverse transcriptases, DNA binding proteins, transcription complex co-factors, RNAi, genes that rescue auxotrophic strains, and the like and/or combinations thereof. The autogene may be part of an “autogene operon” that directs the synthesis of a detectable marker selected from, e.g., a fluorescent protein, GFP, a luminescent protein, luciferase, or an enzyme that can generate fluorescent or luminescent products, an alkaline phosphatase or combinations thereof and the marker comprises an intracellular protein, a secreted protein, a cell surface protein, or combinations thereof. Alternatively or in combination with the detectable marker and/or the autogene, a selection marker may also be found in the autogene operon, e.g., an antibiotic selection marker.

The present invention also includes autogenes that are functional genetic elements, which may include, and/or drive the transcription, and/or express: polymerase genes, an exon, a promoter, an enhancer, a suppressor, a short interfering RNA (siRNA); a micro, interfering RNA (miRNA); a small, temporal RNA (stRNA); or a short, hairpin RNA (shRNA) or combinations thereof.

As used herein, the terms “transcriptional regulatory element,” “TRE” and “transcriptional control region”, “transcriptional response element”, and “transcriptional control element”, are used interchangeably to refer to a polynucleotide sequence, preferably a DNA sequence, which selectively activates transcription of an operably linked polynucleotide sequence in a host cell. A TRE usually includes a promoter region and may optionally include, in addition to a promoter, other control sequences such as enhancers and silencers.

As used herein, the term “heterologous” TRE, promoter or enhancer is used to describe a TRE promoted or enhancer not normally associated in a cell with, or is not derived from, a gene's 5′ flanking sequence. In the context of a gene encoding a product that modulates active levels of at least one gene product of a hypertrophy-sensitive gene, examples of a heterologous promoter or enhancer include an α-myosin heavy chain gene 5′ flanking region.

As used herein, the term “operably linked” is used to define the orientation of polynucleotide elements in a functional relationship. A TRE is operably linked to a coding segment if the TRE promotes transcription of the coding sequence. Operably linked means that the DNA sequences are generally contiguous and, where necessary to join two protein coding regions, contiguous and in the same reading frame. However, since enhancers generally function when separated from the promoter by several kilobases, some polynucleotide elements may be operably linked but not contiguous.

The activity of a TRE in a TRE-reporter gene construct can be assessed after transient expression, or stable cell lines can be created. If a stable cell line is to be created, then the construct also contains a selection gene also referred to as selectable marker. The selection gene encodes a protein necessary for the survival or growth of transformed host cells grown in a selective culture medium. Host cells not transformed with the vector containing the selection gene will not survive in the culture medium. Typical selection genes encode proteins that confer resistance to antibiotics and other toxins, e.g., ampicillin, neomycin, methotrexate or tetracycline, complement auxotrophic deficiencies, or supply critical nutrients not available from complex media. Alternatively, the selectable marker can be contained on a construct separately from the construct containing the TRE-reporter gene, and the two constructs introduced simultaneously into host cells.

As used herein the term “modified base” refers to a non-natural nucleotide of any sort, in which a chemical modification may be found on the nucleobase, the sugar, or the polynucleotide backbone or phosphodiester linkage.

Nucleic acid molecules are said to have “5′ ends” and “3′ ends” because mononucleotides are reacted to make oligonucleotides in a manner such that the 5′ phosphate of one mononucleotide pentose ring is attached to the 3′ oxygen of its neighbor in one direction via a phosphodiester linkage. Therefore, an end of an oligonucleotides referred to as the “3′ end” if its 5′ phosphate is not linked to the 3′ oxygen of a mononucleotide pentose ring and as the “3′ end” if its 3′ oxygen is not linked to a 5′ phosphate of a subsequent mononucleotide pentose ring. As used herein, a nucleic acid sequence, even if internal to a larger oligonucleotide, also may be said to have 5′ and 3′ ends. In either a linear or circular DNA molecule, discrete elements are referred to as being “upstream” or 5′ of the “downstream” or 3′ elements. This terminology reflects the fact that transcription proceeds in a 5′ to 3′ fashion along the DNA strand. For example, the autogene include a promoter that is upstream from the polymerase that it drives the transcription and expression thereof.

The term “gene of interest” as used herein refers to a gene, the function and/or expression of which is desired to be investigated, or the expression of which is desired to be regulated, by the present invention. In the present disclosure, the T7 RNA polymerase gene is an example of a gene of interest and is described herein to illustrate the invention, however, the skilled artisan will recognize that other polymerases, DNA or RNA; viral, prokaryotic or eukaryotic.

The term “hybridize” as used herein, refers to any process by which a strand of nucleic acid binds with a complementary strand through base pairing. Hybridization and the strength of hybridization (i.e., the strength of the association between the nucleic acid strands) is impacted by such factors as the degree of complementary between the nucleic acids, stringency of the conditions involved, the melting temperature of the formed hybrid, and the G:C (or U:C for RNA) ratio within the nucleic acids.

The terms “complementary” or “complementarity” as used herein, refer to the natural binding of polynucleotides under permissive salt and temperature conditions by base-pairing. For example, for the sequence “A-G-T” binds to the complementary sequence “T-C-A”. Complementarity between two single-stranded molecules may be partial, in which only some of the nucleic acids bind, or it may be complete when total complementarity exists between the single stranded molecules. The degree of complementarity between nucleic acid strands has significant effects on the efficiency and strength of hybridization between nucleic acid strands. This is of particular importance in amplification reactions, which depend upon binding between nucleic acids strands.

The term “homology,” as used herein, refers to a degree of complementarity. There may be partial homology or complete homology (i.e., identity). A partially complementary sequence is one that at least partially inhibits an identical sequence from hybridizing to a target nucleic acid; it is referred to using the functional term “substantially homologous.” The inhibition of hybridization of the completely complementary sequence to the target sequence may be examined using a hybridization assay (Southern or Northern blot, solution hybridization and the like) under conditions of low stringency. A substantially homologous sequence or probe will compete for and inhibit the binding (i.e., the hybridization) of a completely homologous sequence or probe to the target sequence under conditions of low stringency. This is not to say that conditions of low stringency are such that non-specific binding is permitted; low stringency conditions require that the binding of two sequences to one another be a specific (i.e., selective) interaction. The absence of non-specific binding may be tested by the use of a second target sequence which lacks even a partial degree of complementarity (e.g., less than about 30% identity); in the absence of non-specific binding, the probe will not hybridize to the second non-complementary target sequence. When used in reference to a single-stranded nucleic acid sequence, the term “substantially homologous” refers to any probe which can hybridize (i.e., it is the complement to the single-stranded nucleic acid sequence under conditions of low stringency as described).

As known in the art, numerous equivalent conditions may be employed to include either low or high stringency conditions. Factors such as the length and nature (DNA, RNA, base composition) of the sequence, nature of the target (DNA, RNA, base composition, presence in solution or immobilization, etc.), and the concentration of the salts and other components (e.g., the presence or absence of formamide, dextran sulfate and/or polyethylene glycol) are considered and the hybridization solution may be varied to generate conditions of either low or high stringency different from, but equivalent to, the above listed conditions.

As used herein the term “stringency” is used in reference to the conditions of temperature, ionic strength, and the presence of other compounds such as organic solvents, under which nucleic acid selections are conducted. With “high stringency” conditions a relatively small number of nucleic acid catalysts will be selected from a random sequence pool, while under “low stringency conditions” a larger number of nucleic acid catalysts will be selected from a random sequence pool.

As used herein, the term “transformation” describes a process by which exogenous DNA enters and changes a recipient cell. It may occur under natural or artificial conditions using various methods well known in the art. Transformation may rely on any known method for the insertion of foreign nucleic acid sequences into a prokaryotic or eukaryotic host cell. The method is selected based on the host cell being transformed and may include, but is not limited to, viral infection, electroporation, lipofection, and particle bombardment. Such “transformed” cells include stably transformed cells in which the inserted DNA is capable of replication either as an autonomously replicating plasmid or as part of the host chromosome.

The term “transfection” as used herein refers to the introduction of foreign DNA into eukaryotic cells. Transfection may be accomplished by a variety of methods known to the art including, e.g., calcium phosphate-DNA co-precipitation, DEAE-dextran-mediated transfection, polybrene-mediated transfection, electroporation, microinjection, liposome fusion, lipofection, protoplast fusion, retroviral infection, and biolistics. Thus, the term “stable transfection” or “stably transfected” refers to the introduction and integration of foreign DNA into the genome of the transfected cell. The term “stable transfectant” refers to a cell that has stably integrated foreign DNA into the genomic DNA. The term also encompasses cells that transiently express the inserted DNA or RNA for limited periods of time. Thus, the term “transient transfection” or “transiently transfected” refers to the introduction of foreign DNA into a cell where the foreign DNA fails to integrate into the genome of the transfected cell. The foreign DNA persists in the nucleus of the transfected cell for several days. During this time the foreign DNA is subject to the regulatory controls that govern the expression of endogenous genes in the chromosomes. The term “transient transfectant” refers to cells that have taken up foreign DNA but have failed to integrate this DNA.

As used herein, the term “selectable marker” refers to the use of a gene that encodes an enzymatic activity and that confers the ability to grow in medium lacking what would otherwise be an essential nutrient (e.g., the HIS3 gene in yeast cells); in addition, a selectable marker may confer resistance to an antibiotic or drug upon the cell in which the selectable marker is expressed. A review of the use of selectable markers in prokaryotic, eukaryotic and even mammalian cell lines is provided in Sambrook, J., et al., Molecular Cloning: A Laboratory Manual, 2nd ed., Cold Spring Harbor Laboratory Press, New York (1989), relevant portions incorporated herein by reference. Selection may even be based on the ability of the polymerase to incorporate one or more non-traditional nucleotides, one or more unnatural nucleotides, one or more ribonucleotides modified at the 2′ position and combinations thereof. Selectable markers for use with the present invention may be under the control of a constitutive or inducible promoter and drive the expression of, e.g., a CAT, a β-lactamase, an aminoglycoside kinase, or other antibiotic resistance marker. In one embodiment, the selective marker is under the control of the same promoter as the autogene.

As used herein, the term “reporter gene” refers to a gene that is expressed in a cell upon satisfaction of one or more contingencies and which, upon expression, confers a detectable phenotype to the cell to indicate that the contingencies for expression have been satisfied. For example, the gene for Luciferase confers a luminescent phenotype to a cell when the gene is expressed inside the cell. In the present invention, the gene for Luciferase may be used as a reporter gene such that the gene is only expressed upon the splicing out of an intron in response to an effector. Those cells in which the effector activates splicing of the intron will express Luciferase and will glow. Cells expressing reporter genes may be selected and/or isolated using, e.g., cell sorting, fluorescence activated cell sorting (FACS), manual sorting, automated sorting and the like.

As used herein, the terms “markers,” “detectable markers” and “detectable labels” are used interchangeably to refer to compounds and/or elements that can be detected due to their specific functional properties and/or chemical characteristics, the use of which allows the agent to which they are attached to be detected, and/or further quantified if desired, such as, e.g., an enzyme, radioisotope, electron dense particles, magnetic particles or chromophore. There are many types of detectable labels, including fluorescent labels, which are easily handled, inexpensive and nontoxic. In some examples, the markers may confer antibiotic resistance, may be auxotrophic, a fluorescent protein, GFP, a luminescent protein, a luciferase, an enzyme that can generate fluorescent or luminescent products, an alkaline phosphatase or combinations thereof.

As used herein, the term “vector” is used in reference to nucleic acid molecules that transfer DNA segment(s) from one cell to another. The term “vehicle” is sometimes used interchangeably with “vector.” The term “vector” as used herein also includes expression vectors in reference to a recombinant DNA molecule containing a desired coding sequence and appropriate nucleic acid sequences necessary for the expression of the operably linked coding sequence in a particular host organism. Nucleic acid sequences necessary for expression in prokaryotes usually include a promoter, an operator (optional), and a ribosome binding site, often along with other sequences. Eukaryotic cells are known to utilize promoters, enhancers, and termination and polyadenylation signals.

As used herein, the term “host cell” refers to cells that have been engineered to contain nucleic acid segments or altered segments, whether archeal, prokaryotic, or eukaryotic. Thus, engineered, or recombinant cells, are distinguishable from naturally occurring cells that do not contain recombinantly introduced genes through the hand of humans. Examples of prokaryotic hosts may include gram negative as well as gram positive bacteria such as, for example, E. coli, S. typhimurium, Serratia marcescens and Bacillus subtilis.

As used herein, the term “amplify”, when used in reference to nucleic acids refers to the production of a large number of copies of a nucleic acid sequence by any method known in the art. Amplification is a special case of nucleic acid replication involving template specificity. Template specificity is frequently described in terms of “target” specificity. Target sequences are “targets” in the sense that they are to be sorted out from other nucleic acid. Amplification techniques have been designed primarily for this sorting out.

As used herein, the term “primer” refers to an oligonucleotide, whether occurring naturally as in a purified restriction digest or produced synthetically, which is capable of acting as a point of initiation of synthesis when placed under conditions in which synthesis of a primer extension product which is complementary to a nucleic acid strand is induced, (i.e., in the presence of nucleotides and an inducing agent such as DNA polymerase and at a suitable temperature and pH). The primer may be single stranded for maximum efficiency in amplification but may alternatively be double stranded. If double stranded, the primer is first treated to separate its strands before being used to prepare extension products. The primer must be sufficiently long to prime the synthesis of extension products in the presence of the inducing agent. The exact length of the primers will depend on many factors, including temperature, source of primer and the use of the method.

As used herein, the term “probe” refers to an oligonucleotide (i.e., a sequence of nucleotides), whether occurring naturally as in a purified restriction digest or produced synthetically, recombinantly or by PCR amplification, which is capable of hybridizing to another oligonucleotide of interest. A probe may be single-stranded or double-stranded. Probes are useful in the detection, identification and isolation of particular gene sequences. It is contemplated that any probe used in the present invention will be labeled with any “reporter molecule,” so that is detectable in any detection system, including, but not limited to enzyme (e.g. ELISA, as well as enzyme-based histochemical assays), fluorescent, radioactive, and luminescent systems. It is not intended that the present invention be limited to any particular detection system or label. As used herein, the term “target” when used in reference to the polymerase chain reaction, refers to the region of nucleic acid bounded by the primers used for polymerase chain reaction. Thus, the “target” is sought to be sorted oat from other nucleic acid sequences. A “segment” is defined as a region of nucleic acid within the target sequence. As used herein, the term “polymerase chain reaction” (“PCR”) refers to the method of K. B. Mullis U.S. Pat. Nos. 4,683,195, 4,683,202, and 4,965,188, hereby incorporated by reference, which describe a method for increasing the concentration of a segment of a target sequence in a mixture of genomic DNA without cloning or purification. This process for amplifying the target sequence consists of introducing a large excess of two oligonucleotide primers to the DNA mixture containing the desired target sequence, followed by a precise sequence of thermal cycling in the presence of a DNA polymerase. The two primers are complementary to their respective strands of the double stranded target sequence.

To effect amplification, the mixture is denatured and the primers then annealed to their complementary sequences within the target molecule. Following annealing, the primers are extended with a polymerase so as to form a new pair of complementary strands. The steps of denaturation, primer annealing and polymerase extension can be repeated many times (i.e., denaturation, annealing and extension constitute one “cycle”; there can be numerous “cycles”) to obtain a high concentration of an amplified segment of the desired target sequence. The length of the amplified segment of the desired target sequence is determined by the relative positions of the primers with respect to each other, and therefore, this length is a controllable parameter. By virtue of the repeating aspect of the process, the method is referred to as the “polymerase chain reaction” (hereinafter “PCR”). Because the desired amplified segments of the target sequence become the predominant sequences (in terms of concentration) in the mixture, they are said to be PCR amplified”.

With PCR, it is possible to amplify a single copy of a specific target sequence in genomic DNA to a level detectable by several different methodologies, e.g., hybridization with a labeled probe; incorporation of biotinylated primers followed by avidin-enzyme conjugate detection; incorporation of ³²P-labeled deoxynucleotide triphosphates, such as DCTP or DATP, into the amplified segment. In addition to genomic DNA, any oligonucleotide sequence can be amplified with the appropriate set of primer molecules. In particular the amplified segments created by the PCR process itself are, themselves, efficient templates for subsequent PCR amplifications.

Modified RNA and DNA molecules have novel properties which their natural counterparts do not possess, such as increased resistance to degradation in cells and improved pharmacokinetic behavior^{1, 2}. In particular, modifications at the 2′-OH of ribose are important for enhancing the stability of RNA^{3, 4}. Unfortunately, it is difficult to enzymatically synthesize modified nucleic acids of any substantial length because natural polymerases are inefficient at the incorporation of modified nucleotides. Previously, the present inventors reported an activity-based method for selecting functional T7 RNA polymerase variants based on the ability of a T7 RNA polymerase to reproduce itself⁵. The original procedure has now been modified to identify polymerases that can efficiently incorporate multiple modified nucleotides at the 2′ position of the ribose. Most importantly, this method allows the selection of polymerases that have good processivities, and can be combined to simultaneously incorporate several different modified nucleotides in a transcript.

Previously, a system was developed in which T7 RNA polymerase was cloned under the control of its own promoter, to create an ‘autogene.’ Upon construction of a polymerase library and transformation, those variants that are more active will generate more mRNA. Mass isolation of the mRNA followed by reverse transcription and PCR leads to the selective amplification of active polymerase variants⁵.

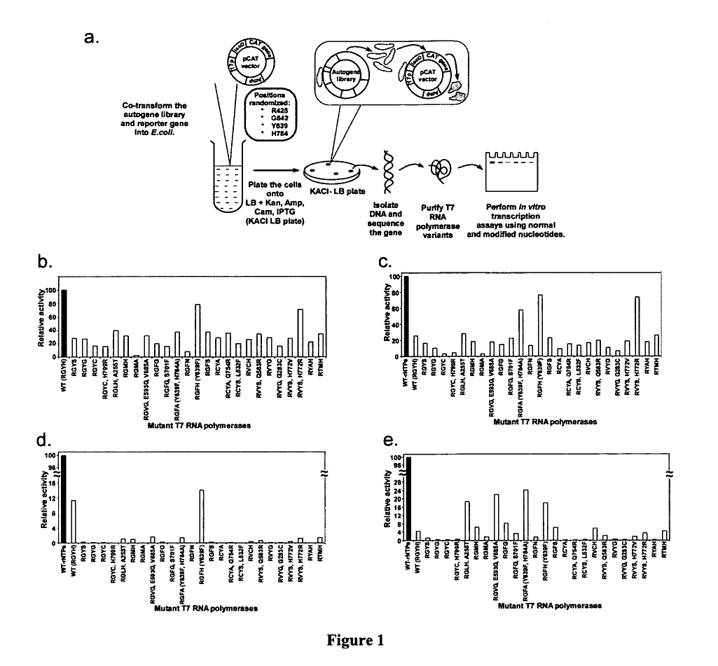

In order to increase the stringency of the initial selection, the autogene selection was modified so that not only did the polymerase need to reproduce itself but it also had to transcribe an antibiotic resistance element (chloramphenicol acetyl transferase, CAT) that was required for cellular survival (FIG. 1a). Following transformation, outgrowth, and plating on chloramphenicol, only those polymerase variants that were active enough to produce sufficient CAT should have survived the selection.

Amino acid positions R425, G542, Y639, and H784 in the T7 RNA polymerase gene were randomized. These positions have been implicated either by previous mutagenesis experiments^{19, 20} or by structural analyses^{21, 22} to be involved in interactions with the 2′ hydroxyl moiety of ribotides.

The library of polymerase variants was cloned behind the T7 RNA polymerase promoter and introduced into E. coli cells along with a vector in which the CAT reporter gene was also under the control of the T7 RNA polymerase promoter. The initial, transformed library consisted of ˜10⁷ to 10⁸ individual clones and was sufficient in size to encompass all the possible permutations of the four randomized codons. After transforming the library into cells harboring the plasmid for the reporter gene, the cells were grown to saturation and induced with IPTG. The population was then plated on media containing 0, 30, 60, or 100 μg/mL chloramphenicol and 1 mM IPTG. Polymerase variants that survived the selection on Cam plates were sequenced. The selection was repeated a number of times in order to ensure that the population had been fully sampled. Twenty-five different mutant polymerases were eventually identified; as expected, many of the same variants were observed more than once.

Sequence analysis of the twenty-five selected variants (Table 1) showed that position R425 was unchanged in all the variants, confirming the importance of this residue for activity and also in maintaining the C3′-endo ribose conformation. A majority of the clones also maintained the glycine residue at position 542. However, at position 639, five polymerase variants had a Tyr to Phe substitution, a well-known amino acid change that increases the ability of the polymerase to incorporate 2′ modified ribotides^{18, 23}. Finally, substitutions at the 784 position were much more diverse. Only five variants retained the H784, while six variants have a Gly or Ser substitution, and 4 variants have an Ala substitution. Taken together, these results verified that the screen taught herein was returning active polymerases with a sufficient diversity of substitutions to search for altered activities.

Following selection, the mutant polymerases were purified via the 6×His tag at the N-terminus of the T7 RNAP gene. In vitro transcription assays were then performed using normal and various 2′ position modified nucleotides. The extent of incorporation into the full-length 80-mer transcript was monitored, and the results of the assays are presented in FIG. 1B-1E.

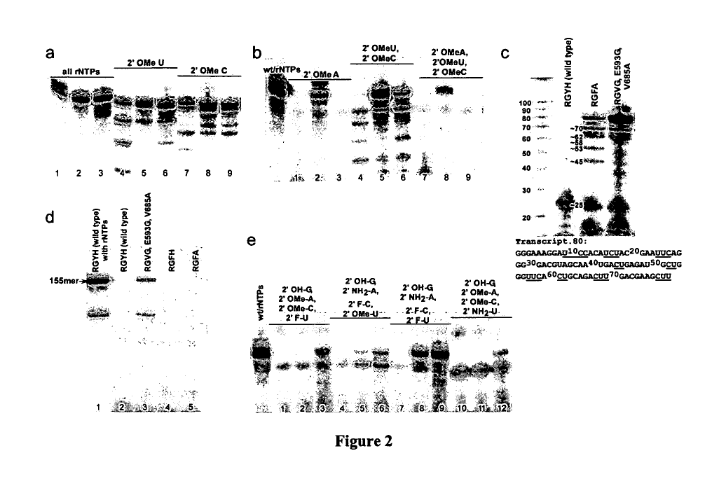

The polymerase variants largely retained the ability to utilize normal ribonucleotides, albeit at a reduced level relative to wild-type (FIG. 1B). In addition, a number of the selected variants were found to efficiently incorporate 2′ modified nucleotides. The ability of the Y639F mutant to optimally incorporate 2′ fluoro pyrimidines (FIG. 1C) and 2′ amino pyrimidines (FIG. 1D), was confirmed, although a novel triple mutant G542V, H784S, H772R (‘RVYS’, H772R) also had considerable activity with fluoropyrimidines. It should be noted that position 772 was not randomized in the initial library, and this substitution probably arose during the construction of the initial library via overlap PCR, which is inherently mutagenic. Directed mutation studies revealed that the mutation at 772 (H772R) did not have any effect on fluoropyrimidine incorporation (data not shown).

When 2′ O-methyl UTP was assayed as a substrate, the best activities were shown by the variants, Y639F, H784A (‘RGFA’ or ‘Sousa variant’), Y639V, H784G, E593G, V685A (‘RGVG,’ E593G, V685A), Y639F (‘RGFH’) and Y639L, A255T (‘RGLH,’ A255T) (FIG. 1E). The Y639F, H784A variant has been shown to improve the incorporation of ribose derivatives containing bulky substituents at the 2′ position (2′methoxy and 2′azido substituents)¹⁷.

Further assays were performed using single and multiple combinations of 2′ O-methoxy nucleotides. The best variant (‘RGVG,’ E593G, V685A) was able to incorporate all the 2′O-methyl nucleotides except 2′-O-methyl GTP, including various combinations of 2′O-methyl nucleotides (FIG. 2A-2B). Although the yield of full-length transcripts that incorporated methoxy nucleotides was low, transcripts as long as 155 nucleotides in length could be generated with 2′-O-methylpyrimidine substitutions (FIG. 2D). Recently, another activity-based selection method has been reported in which a DNA polymerase capable of incorporating 2′-O-methyl derivatives was identified¹⁰. However, the selected DNA polymerase was not very processive and could only add 5 normal nucleotides after the addition of the first modified 2′-O-methyl nucleotide before falling off the template. In contrast, in the case of the 155-mer cited above, 73 of the nucleotides in the full-length transcript were 2′ modified methoxy pyrimidines. Modified RNA polymerases would therefore seem to be of greater biotechnological utility²⁴ (for example, in making modified siRNA for RNA interference studies) than modified DNA polymerases.

In addition to being able to incorporate multiple 2′ O-methyl nucleotides, different polymerase variants could be combined to introduce a number of different modifications in parallel (FIG. 2B). The enzymes ‘RGVG’, E593G, V685A and ‘RGFH’ were used either alone or together (1:1 ratio) in assays with various combinations of modified nucleotides. Although overall yields were low, full-length RNA transcripts were observed even when three different modifications (2′-amino ATP, 2′-fluoro CTP and 2′-O-methyl UTP) were incorporated into transcripts. In general, the transcription efficiency with the two polymerases together was higher than when either one was used singly, even though comparable numbers of units were added to each reaction. For example, in assays where 2′-OMe-ATP was used (see FIG. 2E), transcripts were detected only when mixtures of polymerases were used. The 2′-OMe-ATP was used poorly as a substrate by all mutant enzymes (see FIG. 2B). As a result, combinations of various pyrimidine modifications together with 2′-OMe-ATP also failed to produce transcripts in appreciable amounts even when combinations of enzymes were used (see FIG. 4B, lanes 1,2,3 and 10,11,12). In assays where 2′-NH₂-ATP, 2′-F-CTP, and 2′-OMe-UTP were mixed, approximately 7-fold more product was produced with a polymerase mixture (ratio of lanes 5 and 6 in FIG. 2E). Thus, the polymerases seem able to switch between nascent transcripts in order to introduce their ‘favored’ substrates; the mutant, ‘RGVG’, E593G, V685A was previously found to be more specific towards 2′O-methyl substituents, whereas the Y639F (RGFH) mutant preferred 2′-fluoro and 2′-amino substituents.

While T7 RNA polymerase has been previously reported to traverse through nicks and gaps in the template strand and to bypass branched junctions,²⁵ there was previously no indication that it might switch between transcripts. This finding should allow RNA transcripts with a variety of chemical properties to be made, just as combining DNA polymerases with different processivities and fidelities is now routinely used to generate PCR products of varying lengths and complexities.

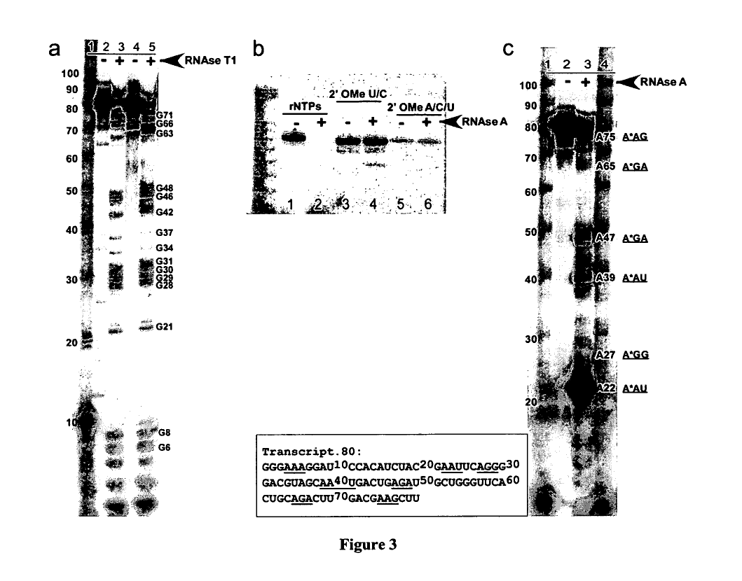

To determine whether the ‘RGVG,’ E593G, V685A variant was faithfully incorporating 2′-O-methyl nucleotides, RNase Ti digestions were performed. The patterns obtained from the digestion of normal RNA made with wild-type T7 RNA polymerase and 2′-O-methylpyrimidine-modified RNA made with the ‘RGVG,’ E593G, V685A variant were very similar (FIG. 3A). It is noteworthy that 2′-OMe modified RNA is highly resistant to cleavage by RNaseA at concentrations where normal RNA is completely degraded (FIG. 3B). The cleavage patterns observed at higher concentrations of RNaseA were consistent with what is known about the mechanism of the enzyme, with cleavage occurring at adenosine residues followed by adenosine or by two purines²⁶ (FIG. 3C). These results further confirm the fidelity of the enzyme in incorporating modified nucleotides.

It should be possible to improve incorporation by further improving processivity. In general, the wild-type polymerase and the ‘RGFA’ variant stalled whenever they had to incorporate multiple 2′-OMe residues, while the ‘RGVG,’ E593G, V785A variant could read through runs of modified nucleotides (FIG. 2C). In this regard, it is important to note that processivity is tested directly, since full-length mRNAs must be produced in vivo in order for colonies that contain a polymerase variant to grow. In contrast, selections for DNA polymerase variants recently reported¹⁰ relied on a strategy in which just four modified nucleotides are added to a primer terminus attached to a phage particle.

Modified RNA transcripts are already finding utility as antisense therapeutics²⁷ and as diagnostic probes²⁸ owing to their improved stabilities and hybridization potential. In particular, 2′-O-methylated RNAs are structurally much more stable than their unmodified counterparts^{28, 29}, and have the advantage that they are naturally found in ribosomal RNA and thus may be of greater applicability for therapy. At present, nuclease resistant aptamers for clinical applications are being prepared using 2′-fluoropyrimidine nucleotides². To the extent that it proves possible to reverse transcribe 2′-O-methyl modified RNAs it should be possible to also use these for the in vitro selection of extensively modified and highly stable RNA aptamers.

Materials and Methods. Vent and Taq polymerases were purchased from New England Biolabs (Beverly, Mass.). The cloning vector pCAT3-promoter was obtained from Promega (Madison, Wis.). ‘Pfu Ultra’ DNA polymerase and BL21(DE3) competent cells used for expression and purification of mutant T7 RNA polymerases were obtained from Stratagene (La Jolla, Calif.). All the modified nucleotides used in transcription reactions were purchased from Trilink Biotechnologies (San Diego, Calif.) and regular NTPs were obtained from Amersham Biosciences (Piscataway, N.J.). The cDNA template that was used for transcription assays, pTRI-RNA-28S, and the enzymes RNaseT1 and RNaseA was obtained from Ambion Inc (Austin, Tex.). All oligonucleotides including primers with randomized regions were obtained from Integrated DNA Technologies (Coralville, Calif.).

Autogene library construction. The T7 autogene library was constructed by randomizing the T7 RNA polymerase gene at positions R425, G542, Y639, and H784. The double-stranded DNA fragments containing each of the random regions were made by PCR using randomized primers in which the codons encoding the amino acids R425, G542, Y639 and H784 were NNN, where N indicates an equimolar mixture of all four bases. The fragments were then assembled by overlapping PCR using ‘Pfu Ultra’ DNA polymerase. The DNA insert that was obtained was digested with Acc65I and Xba1 restriction enzymes and ligated into the wild type ‘T7 autogene’ vector digested with the same enzymes. The ‘T7 autogene’ vector had previously been made by cloning the T7 RNA polymerase gene downstream of the T7 promoter region in a pET28a+ vector, which includes a kanamycin resistance gene^{5, 30}. The reporter gene vector was made by cloning the T7 promoter upstream of the CAT gene in the pCAT3-promoter vector, which also contains an ampicillin resistance gene.

Genetic selection and screen. The autogene library was co-transformed along with the chloramphenicol acetyl transferase reporter gene vector into DH5Δlac cells. The transformed library was allowed to recover in liquid culture in the absence of antibiotics, and the media was then supplemented with 25 μg/mL kanamycin and 100 μg/mL ampicillin and incubated at 37° C. for 2 hrs. The culture was induced with 1 mM isopropyl β-D-thiogalactopyranoside (IPTG) and 30 μg/mL chloramphenicol was added. The cells were allowed to grow at 37° C. for 6 hrs. The saturated culture was then plated on LB plates containing 25 μg/mL kanamycin, 100 μg/mL ampicillin, 1 mM IPTG and varying concentrations (30, 60, and 100 μg/mL) of chloramphenicol. The plates were incubated at 37° C. for 16 hrs. Colonies varied in size, and fewer colonies were seen on plates with higher concentrations of chloramphenicol. Colonies (ca. 15% of the total) were picked from each plate and the polymerase genes sequenced. In parallel, the transformed library was also plated on LB containing kanamycin and ampicillin to estimate the total library size, which was on the order of 10⁷-10⁸. As a negative control, transformants were also plated on LB-kan/amp/cam plates (with no induction); as expected, this study yielded no colonies. The selection/screen was repeated a number of times to sample a larger population of variants.

Purification of mutant polymerases. The autogene plasmids contained a 6× histidine tag at the N-terminus of the polymerase gene and were transformed to BL21(DE3) cells for protein expression and purification. The transformed variants were propagated and induced, and the enzymes were purified by nickel chelate chromatography, according to instructions provided by Qiagen Inc (Chatsworth, Calif.). The purified enzymes were determined to be >99% pure by SDSPAGE and staining with Coomassie blue (data not shown). Purified enzyme concentrations were determined via Bradford protein assays (Bio-Rad, Hercules, Calif.). The wild-type T7 RNA polymerase enzyme was also purified by identical procedures, and was used as a control in all transcription assays.

Analysis of polymerase activity. All transcription reactions using modified nucleotides were carried out for 4 hrs at 37° C. in 40 mM Tris-HCl (pH 8.0), 30 mM MgCl₂, 6 mM spermidine and 10 mM DTT, with templates at 0.8 μM and RNA polymerases at 5×10⁻⁷ M (0.5 μg) final concentrations. All NTPs were used at 6 mM final concentrations in a 10 μL transcription reaction, and the transcripts were labeled by inclusion of 3000 Ci/mmol α-³²P GTP. Reactions were stopped by adding an equal volume of 95% formamide, 20 mM EDTA, and 0.01% bromophenol blue; resolved by electrophoresis on denaturing 8% acrylamide, 1% bisacrylamide, 1×TBE gels; and analyzed on a Molecular Dynamics Phosphorimager (Sunnyvale, Calif.). The 80-nucleotide and 155-nucleotide RNA transcripts obtained from the two DNA templates used in the transcription reactions were:

Transcript-80:

| | |
|---|---|
| GGGAAAGGAUCCACAUCUACGAAUUCAGGGGACGUAGCAAUGACUGAGAUGCUGGGUUC | (SEQ ID NO.:1) |
| ACUGCAGACUUGACGAAGCUU, | |

and

pTri-RNA-28S:

(SEQ ID NO.:2)
GGGAGACUCGAGAAUUACCCUCACUAAAGGGAGGUACCUAACCUGUCUCACGACGGUCUA
AACCCAGCUCACGUUCCCUAUUAGUGGGUGAACAAUCCAACGCUUGGUGAAUUCUGCUUC
ACAAUGAUAGGAAGAGCCGACAUCGAAGGAUCUAGA.

FIG. 1A shows the basic autogene selection scheme of the present invention using active T7 RNA polymerase variants as an example. An autogene library randomized at amino acid residues R425, G542, Y639, and H784 was co-transformed into E. coli along with a compatible reporter vector that confers bacterial resistance to chloramphenicol. Active autogenes that over-express T7 RNA polymerase will also drive the expression of the resistance gene and confer resistance to the antibiotic. Following induction with IPTG, colonies containing active polymerase variants are picked from LB-chloramphenicol plates and the genes and proteins are further characterized, as described in the text.

FIG. 1B through 1E show the relative activities of the selected polymerase variants with regular and modified nucleotides. In all assays, the production of an 80-residue run-off transcript (transcript-80) from a PCR template was quantitated. The activity of the wild-type enzyme with rNTPs is normalized to 100% (indicated by black bars). Relative polymerase activities are shown for: (FIG. 1B) rNTPs, (FIG. 1C) 2′-fluoropyrimidines, (FIG. 1D) 2′-aminopyrimidines, and (FIG. 1E) 2′ O-methyl UTP.

Table 1. Summarizes the sequences of selected polymerase variants. Amino acid substitutions from the original library are shown in bold and have been underlined; additional amino acid substitutions are shown in bold. ‘Silent mutations’ occurred at a rate which is half as for other mutations, but are not shown. Variants that were found more than once from multiple screens are indicated.

TABLE 1

| | | | | | |
|---|---|---|---|---|---|
| Selected | Position | Position | Position | Position | Other |

| | | | | | |
|---|---|---|---|---|---|
| Clones | Arg 425 | Gly 542 | Tyr 639 | His 784 | mutations |

| | | | | | |
|---|---|---|---|---|---|
| *RCYA-1.1 | Arg | Cys | Tyr | Ala | |
| *RGMA-1.2 | Arg | Gly | Met | Ala | |
| *RGFN-1.3 | Arg | Gly | Phe | Asn | |
| *RGYC-1.4 | Arg | Gly | Tyr | Cys | |
| *RGYC-1.7 | Arg | Gly | Tyr | Cys | H799R |
| RYAH-1.18 | Arg | Tyr | Ala | His | |
| *RVCH-1.23 | Arg | Val | Cys | His | |
| RCYS-1.29 | Arg | Cys | Tyr | Ser | L532F |
| *RGLH-2.10 | Arg | Gly | Leu | His | A255T |
| RTMH-2.3 | Arg | Thr | Met | His | |
| RGMH-2.16 | Arg | Gly | Met | His | |
| *RVYS-7.2 | Arg | Val | Tyr | Ser | Q583R |
| *RGFA-7.5 | Arg | Gly | Phe | Ala | |
| RGVG-8.1 | Arg | Gly | Val | Gly | E593G, V685A |
| RGFG-8.2 | Arg | Gly | Phe | Gly | |
| RGFG-8.3 | Arg | Gly | Phe | Gly | S701F |
| RGFH-8.4 | Arg | Gly | Phe | His | |
| RVYG-8.8 | Arg | Val | Tyr | Gly | |
| *RVYS-8.9 | Arg | Val | Tyr | Ser | H772V |
| RGYG-12.1 | Arg | Gly | Tyr | Gly | |
| *RVYG-12.2 | Arg | Val | Tyr | Gly | G283C |
| *RCYA-12.3 | Arg | Cys | Tyr | Ala | Q754R |
| *RGYS-12.21 | Arg | Gly | Tyr | Ser | |
| RGFS-12.24 | Arg | Gly | Phe | Ser | |
| RVYS-12.25 | Arg | Val | Tyr | Ser | H772R |

FIG. 2A through FIG. 2E summarize the polymerase activities with multiple 2′ O-methyl modifications and synthesis of long and complex modified transcripts using the selected polymerases.

FIG. 2A and FIG. 2B show the incorporation of various 2′-OMe modifications. Transcription of an 80-residue transcript (transcript-80) is shown. Transcripts were labeled by the inclusion of α-³²P GTP in the reaction and products were resolved by electrophoresis on an 8% denaturing acrylamide gel. In each set, the first lane is the wild-type polymerase (lanes 1, 4, and 7), while the second lane is the variant ‘RGVG,’ E593G, V685A (lanes 2, 5, and 8), and the third lane is the ‘RGFA’ or ‘Sousa variant’ (lanes 3, 6, and 9). None of the polymerases showed activity with 2′O-methyl GTP (data not shown). The wild-type reaction with rNTPs (first lane in each set) was loaded after 10-fold dilution for ease of quantitation. FIG. 2C shows the decreased stalling by a polymerase variant. Lane 1 is an RNA ladder. The approximate positions at which the wild-type and ‘RGFA’ polymerases stall when incorporating 2′-OMe-UTP and 2′-OMe-CTP are underlined in the transcript-80 sequence. FIG. 2D shows the synthesis of longer transcripts containing 2′-OMe pyrimidines. The wild-type and three polymerase variants were assayed for the incorporation of 2′-OMe-UTP and 2′-OMe-CTP on a DNA template (pTri-RNA-28S) that encoded a transcript of 155 nucleotides in length. FIG. 2E shows the synthesis of complex modified transcripts. Different combinations of modified nucleotides were incorporated into an 80-residue transcript (transcript-80) by polymerase variants. The polymerase variant ‘RGVG’, E593G, V685A is shown in lanes 1, 4, 7, and 10. The variant Y639F is shown in lanes 2, 5, 8, and 11. A 1:1 mixture of the variant polymerases is shown lanes 3, 6, 9, and 12. The overall concentration of added polymerase was the same for each study.

Table 2 summarizes quantitation of the production of full-length transcripts by polymerase variants relative to the wild-type enzyme. The values shown are relative to the activity of the wild-type enzyme with rNTPs, which has been normalized to ‘100.’ ‘n.d’ indicates ‘not determined.’

| | WT | ‘RGVG’, | ‘RGFA’ |
|---|---|---|---|
| | (RGYH) | E593G, V685A | (Y639F, H784A) |
| All r NTPs | 100 | 32 | 37 |
| 2′-OMe-UTP | 7 | 22 | 26 |
| 2′-OMe-CTP | 11 | 42 | 24 |
| 2′-OMe-ATP | n.d | 4 | n.d |
| 2′-OMe-UTP/CTP | n.d | 13 | 3 |
| 2′-OMe-UTP/CTP/ATP | n.d | 1 | n.d |

Next, a series of assays were conducted to demonstrate the fidelity of the mutant enzyme, ‘RGVG’, E593G, V685A and the stability of the 2′-O-methyl modified RNA to nucleases.

FIG. 3A shows the RNaseT1 cleavage pattern of 2′-O-methyl modified RNA synthesized using the mutant enzyme ‘RGVG’, E593G, V685A. Lane 1 is an RNA ladder. Lanes 2 and 3 show the cleavage patterns of normal RNA (transcript-80) synthesized using the wild-type enzyme in the absence and in the presence of RNaseT1 (0.1 Unit, Ambion Inc., Austin, Tex.) respectively. Lanes 4 and 5 show the cleavage of 2′-OMe pyrimidine modified RNA prepared using the mutant ‘RGVG’, E593G, V685A under the same conditions.

FIG. 3B shows the stability of 2′-OMethoxy modified RNA synthesized using the mutant enzyme ‘RGVG’, E593G, V685A to RNaseA. Lanes 1 and 2 show the stability of normal RNA (transcript-80) in the absence and in the presence of RNaseA (Ambion Inc., Austin, Tex.), respectively. Lanes 3 and 4 show the stability of RNA modified with 2′-OMe-C and U, and Lanes 5 and 6 show the stability of RNA modified with 2′-OMe-A, C, and U. The digestions were performed by treating the RNA with 0.001U of the enzyme for 30 min at room temperature. Transcripts were labeled internally by the inclusion of alpha ³²P GTP. FIG. 3C shows the cleavage pattern of 2′-OMethoxy pyrimidine modified RNA at high concentrations of RNaseA. Lanes 1 and 4 is an RNA ladder. Lanes 2 and 3 show the cleavage patterns of 2′-OMe pyrimidine modified RNA (transcript-80) synthesized using the mutant ‘RGVG’, E593G, V685A in the absence and in the presence of high concentrations of RNaseA (1U of RNase A per 0.6 μg RNA) respectively. The RNA was labeled at the 5′ end using gamma ³²P-ATP and polynucleotide kinase. The approximate positions where the cleavage occurred are underlined in the transcript-80 sequence and indicated on the gel, relative to the RNA ladder.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

All publications and patent applications mentioned in the specification are indicative of the level of skill of those skilled in the art to which this invention pertains. All publications and patent applications are herein incorporated by reference to the same extent as if each individual publication or patent application was specifically and individually indicated to be incorporated by reference.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. More specifically, it will be apparent that certain agents which are both chemically and physiologically related may be substituted for the agents described herein while the same or similar results would be achieved. All such similar substitutes and modifications apparent to those skilled in the art are deemed to be within the spirit, scope and concept of the invention as defined by the appended claims.

### REFERENCES

1. Opalinska, J. B. & Gewirtz, A. M. Nucleic-acid therapeutics: basic principles and recent applications. Nat. Rev. Drug Discov. 1, 503-514 (2002).
2. Sullenger, B. A. & Gilboa, E. Emerging clinical applications of RNA. Nature 418, 252-258 (2002).
3. Pieken, W. A., Olsen, D. B., Benseler, F., Aurup, H. & Eckstein, F. Kinetic characterization of ribonuclease-resistant 2′-modified hammerhead ribozymes. Science 253,314-317 (1991).
4. Kurreck, J. Antisense technologies. Improvement through novel chemical modifications. Eur J Biochem 270, 1628-1644 (2003).
5. Chelliserrykattil, J., Cai, G. & Ellington, A. D. A combined in vitro/in vivo selection for polymerases with novel promoter specificities. BMC Biotechnol 1, 13 (2001).
6. Patel, P. H. & Loeb, L. A. DNA polymerase active site is highly mutable: evolutionary consequences. Proc Natl Acad Sci USA 97, 5095-5100 (2000).
7. Ghadessy, F. J., Ong, J. L. & Holliger, P. Directed evolution of polymerase function by compartmentalized self-replication. Proc Natl Acad Sci USA 98, 4552-4557 (2001).
8. Patel, P. H. & Loeb, L. A. Multiple amino acid substitutions allow DNA polymerases to synthesize RNA. J Biol Chem 275, 40266-40272 (2000).
9. Xia, G. et al. Directed evolution of novel polymerase activities: mutation of a DNA polymerase into an efficient RNA polymerase. Proc Natl Acad Sci USA 99, 6597-6602 (2002).
10. Fa, M., Radeghieri, A., Henry, A. A. & Romesberg, F. E. Expanding the substrate repertoire of a DNA polymerase by directed evolution. J Am Chem Soc 126, 1748-1754 (2004).
11. Roychowdhury, A., Illangkoon, H., Hendrickson, C. L. & Benner, S. A. 2′-deoxycytidines carrying amino and thiol functionality: synthesis and incorporation by vent (exo(−)) polymerase. Org Lett 6, 489-492 (2004).
12. Hutter, D. & Benner, S. A. Expanding the genetic alphabet: non-epimerizing nucleoside with the pyDDA hydrogen-bonding pattern. J Org Chem 68, 98399842 (2003).
13. Mitsui, T., Kimoto, M., Sato, A., Yokoyama, S. & Hirao, I. An unnatural hydrophobic base, 4-propynylpyrrole-2-carbaldehyde, as an efficient pairing partner of 9-methylimidazo[(4,5)-b]pyridine. Bioorg Med Chem Lett 13, 45154518 (2003).
14. Switzer, C. Y., Moroney, S. E. & Benner, S. A. Enzymatic recognition of the base pair between isocytidine and isoguanosine. Biochemistry 32, 10489-10496 (1993).
15. Hirao, I., Mitsui, T., Kimoto, M., Harada, Y. & Yokoyama, S. An unnatural base pair for efficient incorporation of nucleotide analogs into RNAs. Nucleic Acids Res Suppl, 215-216 (2003).
16. Sismour, A. M. et al. PCR amplification of DNA containing non-standard base pairs by variants of reverse transcriptase from Human Immunodeficiency Virus-1. Nucleic Acids Res 32, 728-735 (2004).
17. Padilla, R. & Sousa, R. A Y639F/H784A T7 RNA polymerase double mutant displays superior properties for synthesizing RNAs with non-canonical NTPs. Nucleic Acids Res 30, e138 (2002).
18. Padilla, R. & Sousa, R. Efficient synthesis of nucleic acids heavily modified with non-canonical ribose 2′-groups using a mutantT7 RNA polymerase (RNAP). Nucleic Acids Res 27, 1561-1563 (1999).
19. Huang, Y., Eckstein, F., Padilla, R. & Sousa, R. Mechanism of ribose 2′-group discrimination by an RNA polymerase. Biochemistry 36, 8231-8242 (1997).
20. Brieba, L. G. & Sousa, R. Roles of histidine 784 and tyrosine 639 in ribose discrimination by T7 RNA polymerase. Biochemistry 39, 919-923 (2000).
21. Yin, Y. W. & Steitz, T. A. Structural basis for the transition from initiation to elongation transcription in T7 RNA polymerase. Science 298, 1387-1395 (2002).
22. Temiakov, D. et al. Structural basis for substrate selection by T7 RNA polymerase. Cell 116, 381-391 (2004).
23. Sousa, R. & Padilla, R. A mutant T7 RNA polymerase as a DNA polymerase. Embo J. 14, 4609-4621 (1995).
24. Braasch, D. A. et al. RNA interference in mammalian cells by chemically-modified RNA. Biochemistry 42, 7967-7975 (2003).
25. Rong, M., Durbin, R. K. & McAllister, W. T. Template strand switching by T7 RNA polymerase. J Biol Chem 273, 10253-10260 (1998).
26. delCardayre, S. B. & Raines, R. T. Structural determinants of enzymatic processivity. Biochemistry 33, 6031-6037 (1994).
27. Jansen, B. & Zangemeister-Wittke, U. Antisense therapy for cancer—the time of truth. Lancet Oncol 3, 672-683 (2002).
28. Majlessi, M., Nelson, N. C. & Becker, M. M. Advantages of 2′-O-methyl oligoribonucleotide probes for detecting RNA targets. Nucleic Acids Res 26, 2224-2229 (1998).
29. Lesnik, E. A. & Freier, S. M. What affects the effect of 2′-alkoxy modifications? 1. Stabilization effect of 2′-methoxy substitutions in uniformly modified DNA oligonucleotides. Biochemistry 37, 6991-6997 (1998).
30. Chelliserrykattil, J. & Ellington, A. D. in Methods Mol Biol, Vol. 230. (eds. F. H. Arnold & G. Georgiou) 27-43 (Humana Press, Totowa, N.J.; 2003).

What is claimed is:

1. A method of selecting functional genetic elements comprising the step of:
selecting in vivo an autogene operon comprising one or more mutagenized functional genetic elements and one or more selectable elements, wherein propagation of the autogene depends on expression of the one or more mutagenized functional genetic elements and one or more selectable elements.

2. The method of claim 1, further comprising the step of in vitro amplification of the autogene or in vitro amplification of the autogene followed by in vivo selection.

3. The method of claim 1, wherein the functional genetic element comprises a gene, an exon, a promoter, an enhancer, a suppressor, a short interfering RNA (siRNA); a micro, interfering RNA (miRNA); a small, temporal RNA (stRNA); or a short, hairpin RNA (shRNA) or combinations thereof.

4. The method of claim 1, wherein the autogene operon directs the synthesis of a detectable marker a fluorescent protein, GFP, a luminescent protein, luciferase, or an enzyme that can generate fluorescent or luminescent products, an alkaline phosphatase or combinations thereof and which is an intracellular protein, a secreted protein, a cell surface protein, or combinations thereof.

5. The method of claim 1, wherein the selectable marker confers antibiotic resistance to the cell, resistance to viral infection, autotrophic resistance, genetic complementation, enzymatic complementation, a cofactor, resistance against a toxin, a genetic cross-over point or combinations thereof.

6. A method of making an autogene library by mutagenizing the template containing the nucleic acid components;
expressing the autogene library in vivo;
selecting for cells that express the marker;
amplifying in vitro the nucleic acid components; and
iterating the expression in vivo and amplification in vitro of the nucleic acid components.

7. The method of claim 6, in which one of the nucleic acid components is a gene for reverse transcriptase, a regulatory protein, such as a transcription factor, or a binding site for the regulatory protein and combinations thereof.

8. The method of claim 6, in which one of the nucleic acid components is a gene for a tRNA, and one of the nucleic acid components comprise a codon that binds that tRNA.

9. The method of claim 6, in which one of the nucleic acid components is a gene for a tRNA synthetase, and one of the nucleic acid components comprise a codon that will bind the tRNA charged by that tRNA synthetase.

10. A method of selecting enzymatic variants comprising the steps of:
making an autogene library by randomizing one or more residues in the active site of a polymerase enzyme under the control of its own promoter; and
expressing the autogene library in vivo.

11. The method of claim 10, further comprising the step of amplifying in vitro the gene encoding the RNA polymerase enzyme.

12. The method of claim 11, wherein the expression in vivo and amplification in vitro of the nucleic acid components are iterated.

13. The method of claim 10, wherein the polymerase comprises a DNA polymerase, an RNA polymerase, a Reverse Transcriptase, a thermostable DNA polymerase, a thermostable RNA polymerase, a thermostable Reverse Transcriptase or mutants thereof.

14. The method of claim 10, further comprising a marker that can be screened for placed under the control of the RNA polymerase promoter and cells containing RNA polymerase variants are isolated by screening or selection.

15. The method of claim 10, where the autogene library is made by overlap PCR of double stranded DNA fragments containing randomized regions in the polymerase gene, which are initially made by PCR using primers containing randomized codons.

16. The method of claim 10, wherein the marker confers antibiotic resistance, are auxotrophic, a fluorescent protein, GFP, a luminescent protein, a luciferase, an enzyme that can generate fluorescent or luminescent products, an alkaline phosphatase or combinations thereof.

17. The method of claim 10, wherein the polymerase incorporates one or more non-traditional nucleotides, one or more unnatural nucleotides, one or more ribonucleotides modified at the 2′ position and combinations thereof.

18. The method of claim 10, wherein the polymerase is an RNA polymerase that comprises a T7 polymerase with one or more of the following mutations: Tyr639Val, His784Gly, Glu593Gly, Val685Ala and combinations thereof.

19. The method of claim 10, wherein the RNA polymerase is screened for one or more of the following: initiation with non-canonical nucleotides, use of different promoter sequences, improved activity, thermostability, or combinations thereof.

20. The method of claim 10, further comprising placing a selectable marker under the control of the promoter selected from a CAT, a β-lactamase, an aminoglycoside kinase, or other antibiotic resistance marker.

21. A vector comprising a polymerase promoter, a mutant polymerase under the control of the polymerase promoter and a selectable marker under the control of the polymerase promoter.

22. The vector of claim 21, wherein the vector comprises regulatory elements that modulate the expression of the polymerase.

23. The vector of claim 21, wherein the vector comprises regulatory elements that modulate the expression of the polymerase comprises the lac operator.

24. The vector of claim 21, wherein a gene in the vector comprises an epitope tag that facilitates the purification of the polymerase.

25. The vector of claim 21, wherein a gene product expressed from the gene in the vector comprises an epitope tag selected from a His-tag, a myc-tag, a FLAG-tag, a GST, an MBP, or combinations thereof.

26. The vector of claim 21, wherein the vector comprises a viral and a bacterial origin of replication.

27. The vector of claim 21, further comprising the step of sequencing the polymerase gene at or about the active site.

28. The vector of claim 30, wherein the polymerase comprises a DNA polymerase, an RNA polymerase, a Reverse Transcriptase, a thermostable DNA polymerase, a thermostable RNA polymerase, a thermostable Reverse Transcriptase or mutants thereof.

29. A host cell comprising a vector comprising a polymerase promoter, a mutant polymerase under the control of the polymerase promoter and a selectable marker under the control of the polymerase promoter.

30. A method of selecting nucleic acid polymerases that incorporate non-traditional nucleotides comprising the steps of:
introducing into one or more cells that are deficient in nucleotide synthesis a vector comprising a RNA polymerase promoter, a mutant RNA polymerase under the control of the polymerase promoter and a selectable marker under the control of the RNA polymerase promoter; and selecting for one or more cells that survive selection.

31. The method of claim 30, wherein the cell is a eukaryotic cell.

32. The method of claim 30, wherein the cell is a bacterial cell.

33. The method of claim 30, wherein the vector comprises a phagemid.

34. A method of making RNA polymerases that incorporate non-traditional nucleotides comprising the steps of:
selecting for one or more cells having a vector comprising a RNA polymerase promoter, a mutant RNA polymerase under the control of the polymerase promoter and an antibiotic resistance element under the control of the RNA polymerase promoter.

35. A method of selecting functional genetic elements comprising the step of:
selecting in vivo an autogene operon comprising one or more mutagenized functional genetic elements and one or more screenable elements, wherein propagation of the autogene depends on expression of the one or more mutagenized functional genetic elements and one or more screenable elements.

36. The method of claim 35, further comprising the step of in vitro amplification of the autogene.

37. The method of claim 35, further comprising the step of in vitro amplification of the autogene followed by in vivo selection.

38. The method of claim 35, wherein the functional genetic element comprises a gene, an exon, a promoter, an enhancer, a suppressor, a short interfering RNA (siRNA); a micro, interfering RNA (miRNA); a small, temporal RNA (stRNA); or a short, hairpin RNA (shRNA) or combinations thereof.

39. The method of claim 35, wherein the autogene operon directs the synthesis of a detectable marker selected from a fluorescent protein, GFP, a luminescent protein, luciferase, or an enzyme that can generate fluorescent or luminescent products, an alkaline phosphatase or combinations thereof and the marker comprises an intracellular protein, a secreted protein, a cell surface protein, or combinations thereof.

40. The method of claim 35, wherein the selectable marker confers antibiotic resistance to the cell, resistance to viral infection, autotrophic resistance, genetic complementation, enzymatic complementation, a cofactor, resistance against a toxin, a genetic cross-over point or combinations thereof.

41. A method of selecting and screening of polymerases comprising the steps of:
selecting for one or more cells having a vector comprising a polymerase promoter, a mutant polymerase under the control of the polymerase promoter and an antibiotic resistance element under the control of the polymerase promoter.

42. A kit comprising a container comprising a vector comprising a polymerase promoter, a mutant polymerase under the control of the polymerase promoter and a selectable marker under the control of the polymerase promoter
